(19) United States
(12) Patent Application Publication
(10) Pub. No.: US 2026/0119710 A1
(43) Pub. Date: Apr. 30, 2026

(54) DYNAMIC REDACTION AND REGENERATION OF A SOFTWARE APPLICATION

(71) Applicant: ServiceNow, Inc., Santa Clara, CA (US)

(72) Inventor: Matthew Thomas McDonald, Callahan, FL (US)

(21) Appl. No.: 18/930,753

(22) Filed: Oct. 29, 2024

(51) Int. Cl. G06F 21/62; G06F 8/70; G06F 11/36

(52) U.S. Cl. CPC G06F 21/6254; G06F 8/70; G06F 11/3688

(57) ABSTRACT

Aspects of the subject technology relate to systems, methods, and computer-readable media for automatically obfuscating data or components of a software application that may be indicative of an entity or contain sensitive internal information of the entity while preserving the functionality of the software application. An example method can include accessing, via a proxy server, a software application comprising a plurality of components and associated with an organization. The method can further include identifying, among the plurality of components, one or more sensitive components and generating, for each of the one or more sensitive components, a respective censored component. Based on the software application, a censored software application can be generated by replacing each of the one or more sensitive components with the respective censored component. Further, access to the censored software application can be provided, via the proxy server, to a security testing resource.

### BACKGROUND

### 1. Technical Field

The present disclosure generally relates to dynamic redaction of components of a software application and more specifically, to dynamically obfuscating data or components of a software application that may be indicative of an entity or contain sensitive internal information of the entity.

### 2. Introduction

Entities, such as business enterprises, implement various security practices (e.g., a Secure Software Development Life Cycle (SSDLC) process) throughout the development of software applications. In particular, when deploying a software application in a functional state, security considerations can be incorporated at every stage of development to enhance software application security. A security testing party can perform a set of security tests to identify security vulnerabilities within the functional software application. The security testing of a software application helps reduce vulnerabilities and improve the overall protection of the software application.

### BRIEF DESCRIPTION OF THE DRAWINGS

The various advantages and features of the present technology will become apparent by reference to specific implementations illustrated in the appended drawings. A person of ordinary skill in the art will understand that these drawings only show some examples of the present technology and would not limit the scope of the present technology to these examples. Furthermore, the skilled artisan will appreciate the principles of the present technology as described and explained with additional specificity and detail through the use of the accompanying drawings in which:

FIG. 1A illustrates a diagram of an example cloud computing architecture, according to some examples of the present disclosure.

FIG. 1B is a block diagram illustrating an example network architecture that can be used to implement one or more aspects, components, devices, nodes, systems, instances, and/or portions of the example cloud computing architecture, according to some examples of the present disclosure.

FIG. 2 is a diagram illustrating an example system process for obfuscating data of a software application that may contain sensitive internal information for security testing, according to some examples of the present disclosure.

FIG. 3A illustrates example configurations of an interface before and after redacting data of a software application that contains sensitive internal information, according to some examples of the present disclosure.

FIG. 3B illustrates example configurations of an interface before and after regenerating a component of a software application that contains sensitive internal information, according to some examples of the present disclosure.

FIG. 4 illustrates a flowchart of an example method of generating a censored software application to obfuscate sensitive component(s) for security testing, according to some examples of the present disclosure.

FIG. 5 is an example of a deep learning neural network that can be used to implement all or a portion of the systems and techniques described herein, according to some examples of the present disclosure.

FIG. 6 is a diagram illustrating an example architecture of an example transformer model, according to some examples of the present disclosure.

FIG. 7 illustrates an example processor-based system with which some aspects of the subject technology can be implemented, according to some examples of the present disclosure.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form to avoid obscuring the concepts of the subject technology.

Due to resource constraints and/or contractual obligations, some entities rely on an external party (e.g., a third-party contractor outside of the entities) to perform security testing of a software application. However, involving an external party for security testing can expose the entity to risks, as the external party may gain access to proprietary systems and disclosure of potential security vulnerabilities. For example, the third party can access sensitive data and/or intellectual property during security testing. Countermeasures for mitigating these risks are often limited to contractual agreements such as non-disclosure agreements (NDAs) between the entity and the external security testing party.

The disclosed technology addresses the foregoing by automatically obfuscating data or components of a software application that may be indicative of an entity or contain sensitive internal information of the entity while preserving the functionality of the software application. Specifically, the disclosed technology can identify components of a software application that contain identifiable features related to the entity (e.g., names, logos, symbols, profiles, contact information, etc.) and obfuscate/censor/remove those components from the software application. Further, an artificial intelligence (AI) model can be used to generate an updated component(s), without entity-identifiable features, to replace the removed components. In some examples, a generative AI model can be used to regenerate a textual component that includes a text with a length exceeding a threshold length. For example, a generative AI model can summarize the text and eliminate a term(s) indicative of an entity to generate a new textual component of the software application.

Furthermore, the disclosed technology can provide solutions for establishing a secure connection between an entity associated with a software application and an external security testing source by facilitating communication through a proxy server. Specifically, restricted access to the regenerated software application can be provided, via the proxy server, to the security testing resource without having to grant direct access to an internal system of the entity or expose any identifiable information related to the entity.

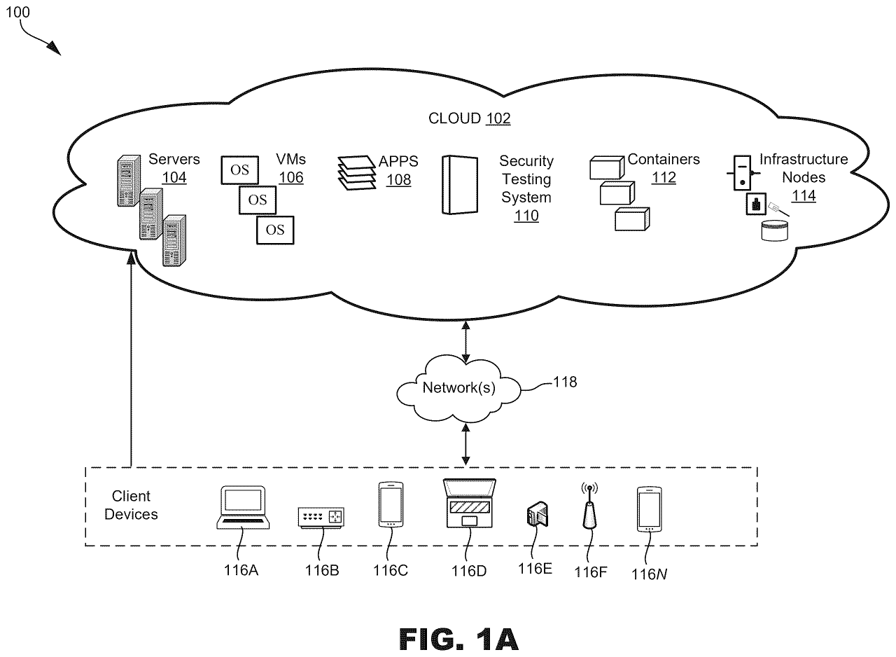

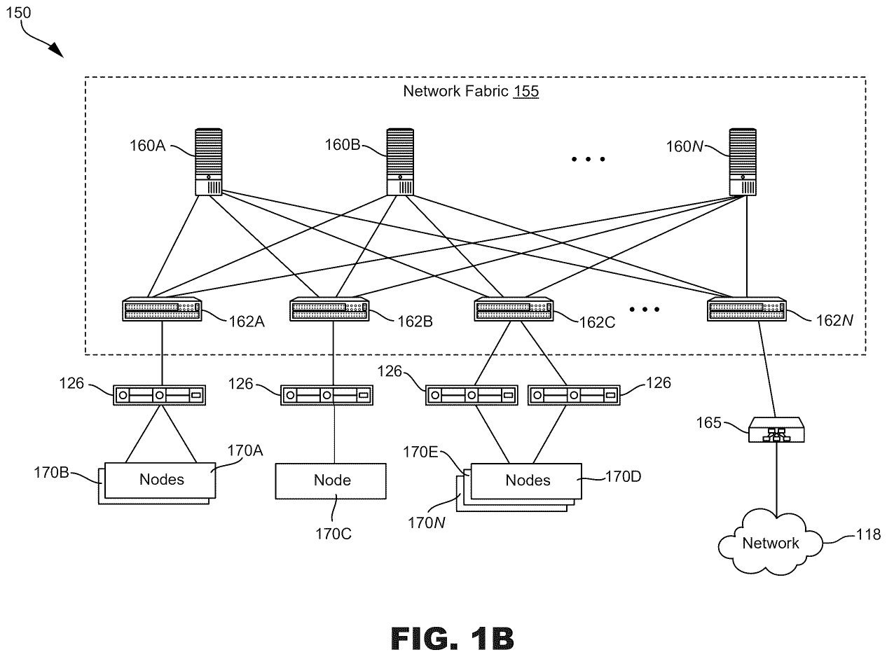

FIG. 1A illustrates a diagram of an example cloud computing environment 100 that can be used to implement a security testing façade system, according to some examples of the present disclosure. The cloud computing environment 100 can include and/or represent a cloud 102. The cloud 102 can include one or more private clouds, public clouds, and/or hybrid clouds. Moreover, the cloud 102 can include cloud elements 104-114. The cloud elements 104-114 can include or represent, for example, servers 104, virtual machines (VMs) 106, applications or services 108, security testing system 110, software containers 112, and/or infrastructure nodes 114. The infrastructure nodes 114 can include various types of nodes, such as compute nodes, storage nodes, network nodes, management systems, etc.

The cloud 102 can provide cloud computing services via the cloud elements 104-114, such as software as a service (SaaS) (e.g., collaboration services, email services, enterprise resource planning services, content services, communication services, etc.), infrastructure as a service (IaaS) (e.g., security services, networking services, systems management services, etc.), platform as a service (PaaS) (e.g., web services, streaming services, application development services, etc.), and other types of services such as desktop as a service (DaaS), information technology management as a service (ITaaS), managed software as a service (MSaaS), mobile backend as a service (MBaaS), etc.

The client devices 116A-N (collectively referred to as “client devices 116” hereinafter) can connect with the cloud 102 to obtain one or more specific services from the cloud 102. The client devices 116 can connect with the cloud 102 from any network of the client devices 116 such as a local area network (wired and/or wireless), a cellular network, and/or any other network, and using the network(s) 118 to transport communications between the cloud 102 and the client devices 116. For example, the client devices 116 can communicate with the cloud 102 and/or any of the elements 104-114 via a network(s) 118. The network(s) 118 can include one or more public networks (e.g., the Internet, a wide area network, etc.), one or more private networks (e.g., local area network(s), wireless local area network(s), private backbone network(s), etc.), and/or one or more hybrid networks (e.g., virtual private network(s), public and private cloud network(s), etc.).

The client devices 116 can include any device with networking capabilities, such as a laptop computer, a tablet computer, a server, a desktop computer, a smartphone, a network device (e.g., an access point, a router, a switch, etc.), a smart television, a smart car, a sensor system, a gaming console, a smart wearable device (e.g., smartwatch, etc.), an internet of things (IoT) device, a camera, a network printer, or any other computing device.

In some examples, the cloud 102 can implement security testing system 110 associated with one or more entities. The client devices 116 can access the security testing system 110 implemented and/or hosted in the cloud 102 to generate a censored software application for security testing, as further described herein. An example network architecture that can be used to implement a network or datacenter (or any portion thereof), such as the cloud 102, is shown in FIG. 1B and further described below. In some cases, one or more services, components, devices, nodes, systems, instances, and/or portions of the example network architecture 150 shown in FIG. 1B can be implemented by and/or in a cloud network or datacenter, such as the cloud 102.

FIG. 1B is a block diagram illustrating an example network architecture 150 that can be used to implement one or more portions of the example cloud computing environment 100, according to some examples of the present disclosure. The example network architecture 150 in FIG. 1B can represent, implement, deploy, host, support, include and/or provide the infrastructure for (or a portion of the infrastructure for) a datacenter (e.g., a cloud datacenter, an on-premises datacenter, a hybrid datacenter including private and public datacenters or datacenter portions, etc.), a network infrastructure, and/or any network environment (or portion thereof) such as, for example and without limitation, a cloud network/environment, a campus network/environment, an enterprise network/environment, an on-premises network/environment, a private network/environment, a public network/environment, a hybrid network/environment (e.g., a network/environment including both private and public networks/environments or portions thereof), and/or the like.

In some examples, the example network architecture 150 can host, implement, deploy, provide (e.g., provide the infrastructure for or a portion of the infrastructure for), support, and/or run/execute one or more applications, virtual machines (VMs), software containers, software tools, software functions, software algorithms, software models (e.g., artificial intelligence and machine learning models, software models implementing one or more classical algorithms, etc.), software applications, software packages, domains, databases, networks, services, workloads, service chains, functions, controllers, virtual network functions (VNFs), servers, drivers, hardware and/or software resources, software and/or hardware devices, software and/or hardware nodes, networking elements, serverless environments, serverless functions, cloud services and/or applications (e.g., software-as-a-service, function-as-a-service, infrastructure-as-a-service, platform-as-a-service, cloud applications, and/or any other cloud services and/or applications), execution environments, storage systems, processing/compute systems, memory systems, software and/or network sites, software policies, virtual/logical networks, overlay networks, software-defined networks (SDNs), interfaces, and/or any other code, component, element, application, service, etc.

For example, the network architecture 150 can include, represent, implement, support, run, host, and/or provide the infrastructure for (or a portion of the infrastructure for) a datacenter, network (e.g., a cloud or cloud network, an on-premises network, a private network, a public network, a hybrid network, etc.), network infrastructure, and/or network environment used to host, implement, support, deploy, provide, and/or run workloads/nodes. In some cases, a cloud node can implement, include, represent, support, run, host, and/or provide one or more software applications/services, software systems, software packages, software modules, software units, software tools, interfaces, software/application code, functions, virtual environments, virtual applications, execution environments, virtualization elements (e.g., operating system-level virtualization elements, application-level virtualization elements, etc.), platforms, and/or any other components. In some cases, the node can host and run one or more software containers, VMs, VNFs, applications (e.g., container applications, VM applications, and/or any other software applications), operating systems (OSs), functions, tools, and/or any other execution environment, code, tool, component, element, and/or package.

As shown in FIG. 1B, the network architecture 150 can include a network fabric 155. The network fabric 155 can include and/or represent the physical layer (e.g., underlay) and/or infrastructure of the network architecture 150. In some cases, the network fabric 155 can represent a data center(s) of one or more networks such as, for example, the cloud 102. The network fabric 155 can include network devices 160A-N (collectively referred to as “network devices 160” hereinafter) and network devices 162A-N (collectively referred to as “network devices 162” hereinafter), which are interconnected to route, relay, forward, and/or switch traffic in the network fabric 155. In some examples, the network devices 160 and the network devices 162 can include, implement, represent, and/or operate as switches (e.g., Layer 2 and/or Layer 3 switches, aggregation switches, ingress and/or egress switches, top-of-rack (ToR) switches, core switches, spine switches, leaf switches, etc.), routers, hubs, bridges, gateways, provider edge devices, firewalls, network controllers, and/or any other type of networking devices. In FIG. 1B, the network fabric 155 includes or implements a spine-leaf topology. In such examples, the network devices 160 can represent spine nodes (e.g., spine switches or routers) and the network devices 162 can represent leaf nodes (e.g., leaf switches or routers). In other examples, the network fabric 155 can alternatively or additionally include or implement any other network topology.

The network devices 160 are interconnected with the network devices 162, and the network devices 162 can connect the network 118, the system servers 126, the network device 165, and/or the nodes 170A-N (collectively referred to as “nodes 170” hereinafter) with any portion of the network fabric 155 (e.g., including each other). In some cases, the network fabric 155 can include, host, and/or implement a network overlay(s) or logical network(s) that includes or implements one or more application services, servers, VMs, software containers, virtual resources (e.g., storage, memory, processors, network interfaces, virtual tools, execution environments, etc.), workloads, functions, virtual networks, hardware and/or software resources, and/or any other element(s).

Network connectivity in the network fabric 155 can flow from the network devices 160 to the network devices 162, and vice versa. The network devices 162 can route, switch, relay, forward, and/or bridge network traffic to and from other portions of the network fabric 155, other networks, e.g., network 118, various network elements, the network device 165, the nodes 170, external client devices (e.g., clients devices external to the network fabric 155), data centers, clouds, tunnels, software-defined networks (SDNs) and/or SDN branches, on-premises networks, cloud tenants, cloud customers, applications, and/or any other network element. Thus, the network devices 162 can connect networks and network elements of the network fabric 155 with each other and with other networks and network elements.

In FIG. 1B, the system servers 126 can include or represent computer servers. Each of the system servers 126 can host, include, implement, and/or run one or more applications, functions, services, VMs, software containers, service chains, workloads, AI/ML models, algorithms, resources, cloud appliances, and/or any other software. For example, the system servers 126 can implement any of the applications 108 and/or the security testing system 110 hosted on the cloud 102. In some cases, the system servers 126 connected to the network devices 162 can encapsulate and decapsulate packets to and from the network devices 162. For example, the system servers 126 can include, host, implement and/or operate one or more virtual routers, switches, gateways, endpoints, and/or network devices for tunneling packets between an overlay or logical layer hosted by, or connected to, the system servers 126 and an underlay layer represented by or included in the network fabric 155.

As shown in FIG. 1B, the system servers 126 can host, include, run, operate, and/or implement the nodes 170. In some examples, the nodes 170 can represent cloud instances. For example, in some cases, the nodes 170 can each represent a virtual server and/or environment (e.g., a VM, a software container, etc.) that uses compute, memory, storage, and/or networking resources on the cloud (e.g., network architecture 150) for respective workloads. For example, the nodes 170 can implement any of the applications 108 and/or the security testing system 110 hosted on the cloud 102. In some implementations, the nodes 170 can perform parallel computing using, for example, multithreading. Each of the nodes 170 can include, host, implement, run, operate, and/or represent one or more server applications, software containers, VMs, software, services, AI/ML models, algorithms, cloud appliances, software functions, service chains, workloads, server-side functions, processing resources, computers, and/or any other software and/or hardware component.

For example, in some cases, each of the nodes 170 can represent a node instance that includes, implements, hosts, and/or runs a software container(s), an application(s), and/or a security testing system(s). In some examples, a software container(s) associated with a node can provide, run, deploy, include, operate, represent, and/or implement an execution environment(s), a workload(s), an application(s), software, an AI/ML model(s), an algorithm(s), a driver(s), a computer service(s), a software model(s) and/or algorithm(s), a function(s), a software library/libraries, a software tool(s), a software/cloud appliance(s), a software component(s), and/or any other computing element(s). In some cases, the nodes 170 can represent cloud node instances running respective computing environments, such as software containers or VMs. Each VM can include software, services, drivers, applications, libraries, functions, virtualized resources (e.g., processors, memory, storage, network interfaces, etc.), and/or workloads installed, implemented, included, and/or running/executed on a guest operating system (OS) associated with the VM.

The network architecture 150 can deploy, run, implement, host, and/or support various resources (e.g., hosts, applications, services, functions, VMs, software containers, workloads, cloud appliances, service chains, hardware and/or software resources, AI/ML models, algorithms, application platforms, operating systems, etc.) using the system servers 126, the network fabric 155, the network devices 160, the network devices 162, the network device 165, the nodes 170, and/or the network 118.

In some cases, the network architecture 150 can implement and/or can be part of one or more cloud networks and can provide one or more cloud computing services such as, for example and without limitation, cloud storage, serverless computing, software-as-a-service (SaaS) (e.g., streaming services, content delivery services, video services, Internet content services, application services, conferencing services, etc.), infrastructure-as-a-service (IaaS), platform-as-a-service (PaaS) (e.g., web services, streaming services, content delivery services, content library services, conferencing services, video services, Internet content services, sharing and/or collaboration services, etc.), function-as-a-service (FaaS), and/or any other types of services such as desktop-as-a-service (DaaS), information technology management-as-a-service (ITaaS), managed software-as-a-service (MSaaS), mobile backend-as-a-service (MBaaS), etc.

The network architecture 150 described above illustrates a non-limiting example network architecture provided herein for explanation purposes. It should be noted that other network architectures can be implemented in other examples and are also contemplated herein. One of ordinary skill in the relevant art(s) will recognize in view of the disclosure that other network architectures can be used to implement one or more of the concepts, systems, techniques, devices, software, applications, methods, embodiments, elements, examples, and/or components disclosed herein.

An enterprise network and/or a security testing system associated with an entity can be implemented through the cloud computing environment 100 shown in FIG. 1A and the network architecture 150 shown in FIG. 1B. For example, security testing system 110 for performing security tests or utilizing an external party for security testing can be implemented through the cloud computing environment 100 and/or the network architecture 150.

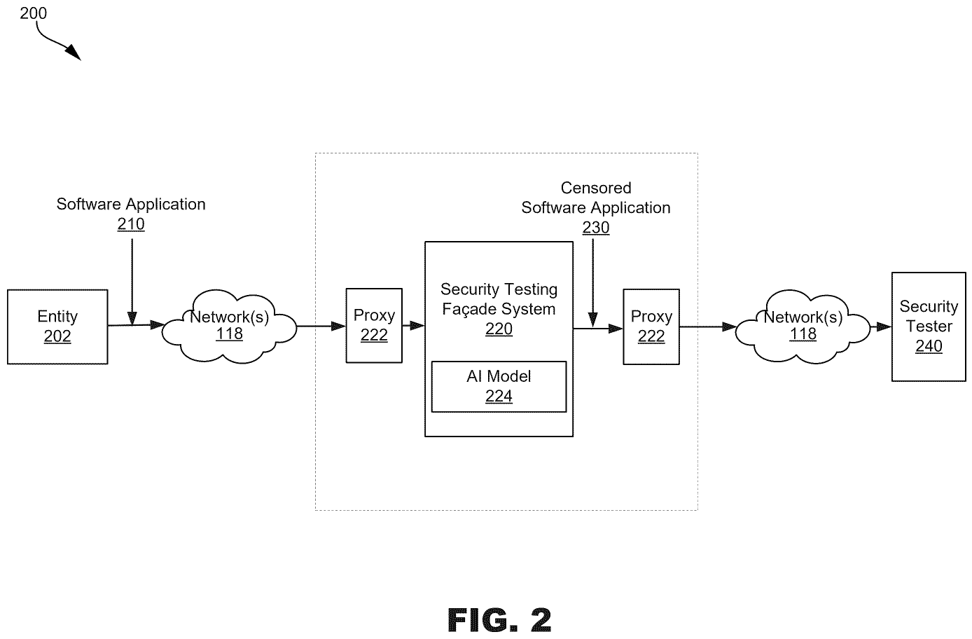

FIG. 2 illustrates an example system process 200 for obfuscating data of a software application that may contain sensitive internal information for security testing, according to some examples of the present disclosure. In this example, a user (not shown) associated with an entity 202 can use a client device (e.g., client device(s) 116A-116N) to provide a software application 210 to security testing façade system 220, which is configured to regenerate the software application into a censored software application 230 for security testing. The security testing façade system 220 in this example can represent or be part of security testing system 110 in cloud 102 shown in FIG. 1A.

In this example, software application 210 can include a software program that is developed by entity 202 or to be deployed by entity 202. A set of security tests can be performed to identify security vulnerabilities of software application 210. For example, security tester 240 is configured to evaluate and verify vulnerabilities and security controls of software application 210, which is associated with entity 202. The security testing façade system 220 is configured to operate in a position between entity 202 and security tester 240 such that a functional façade can be provided to software application 210 prior to being provided to security tester 240. For example, security testing façade system 220 can censor any portion of software application 210 that may include internal sensitive information and pass the censored software application 230 to security tester 240 for security testing.

In some implementations, security testing façade system 220 provides proxy 222 between entity 202 and security tester 240. For example, proxy 222 can act as a gateway that manages communication between entity 202 and security tester 240. The proxy 222 can be a software-based proxy, a hardware-based proxy, a cloud-based proxy, or a combination thereof.

As shown in FIG. 2, security testing façade system 220 can, over network 118, access or retrieve software application 210, which is developed by or to be deployed by entity 202. Non-limiting examples of software application 210 can include a web-based application, a mobile application, an application programming interface (API), and so on. In some examples, software application 210 can comprise a plurality of components, for example and without limitation, visualization components representing the user interface (UI) and functional components responsible for performing operations, processing data, and carrying out the core logic and functionality of software application 210.

In some examples, security testing façade system 220 can identify various components of software application 210 associated with entity 202. For example, security testing façade system 220 can parse raw data of software application 210 to identify a plurality of components.

The security testing façade system 220 can identify, among the plurality of components of software application 210, visualization components that do not affect or relate to the functionality of software application 210. Non-limiting examples of the visualization components can include buttons (e.g., interactive elements), text boxes, input fields, dropdown menus, navigation bars (e.g., menus or tabs), charts and graphs, icons, progress bars, sliders, background image, labels, and so on.

Further, security testing façade system 220 can identify a portion or component(s) of software application 210 that may be indicative of entity 202 or contain sensitive internal information of entity 202. The sensitive internal information can include any organizational information, for example and without limitation, a name, a logo, a symbol, a branding, a phone number, an address, an email address, member(s), employee(s), or participant(s), an entity structure, and contact information associated with the organization.

In some examples, security testing façade system 220 can include an AI model 224, which is configured to detect a component(s) of software application 210 that needs to be redacted or regenerated before software application 210 is provided to security tester 240 for security testing. For example, AI model 224 can automatically identify one or more components of software application 210 that include features that are associated with entity 202 or include internal information associated with entity 202.

The AI model 224 can include one or more software algorithms (e.g., AI/ML models such as a large language model (LLM)). The AI model 224 can implement a single AI/ML model or multiple AI/ML models. In some examples, AI model 224 can implement a neural network(s), a neural network head(s), a neural network branch(es), a neural network core(s), a neural network interface(s) (e.g., application-specific interfaces (APIs), etc.), and/or any other components. Each of the neural network(s) can include any neural network type/architecture such as, for example and without limitation, a transformer network, a convolutional neural network, an autoencoder network, a sequence-to-sequence network, a recurrent neural network, a long short-term memory network, a mixture-of-experts network, an encoder and/or decoder network (e.g., encoder-decoder network, encoder-only network, decoder-only network, etc.), and/or any other artificial and/or deep learning neural network.

In some implementations, AI model 224 can be trained using organization data to learn internal information associated with entity 202 to help AI model 224 identify accurately components of software application 210 for redaction and/or regeneration. For example, AI model 224 can be trained with organizational information that describes characteristics, structures, intellectual property, or any applicable data associated with entity 202.

The security testing façade system 220 can obscure the component(s) that are identified for redaction and/or regeneration. For example, any portion of software application 210 that includes visualization components or sensitive internal information associated with entity 202 can be masked such that any sensitive component particularly related to entity 202 can be hidden from security tester 240.

The security testing façade system 220 can further simplify any component of software application 210 that includes unnecessary information or graphical component (e.g., background image, patterns, icons, graphics, etc.) that is not needed for security testing. For example, security testing façade system 220 can simplify or strip off any component of software application 210 that does not affect the functionality of software application 210 such that a bare-bone version of software application 210 can be provided to security tester 240.

Further, security testing façade system 220 can redact or regenerate the above-identified components of software application 210 such as visualization components (e.g., graphical elements), entity-identifiable components, and/or sensitive information containing components. For example, security testing façade system 220 can redact the exposed variables, input fields, labels, text boxes, and so on. Also, security testing façade system 220 can rename or replace the redacted variables, fields, labels, or text boxes with a generic representation.

In some implementations, security testing façade system 220 can identify, among a plurality of components, a textual component of software application 210 (e.g., an error message, an instructional text, a notification, etc.). The security testing façade system 220 can further determine a length of the text in the textual component. If the text length exceeds a predetermined threshold length, security testing façade system 220 can summarize the text into a concise text where the length of the summarized text is below a predetermined summary threshold. In some examples, security testing façade system 220 can use a generative AI model to summarize the text (referred to as generative AI summarization) and generate a new text to represent the original text in a more compact form. For example, a generative AI model can extract key sentences and/or words from the original text (extractive summarization) and transform the length text into a shorter version.

In some examples, security testing façade system 220 can map functional components of software application 210 onto censored software application 230 without any change or modification. In other words, functional components are unchanged from the software application 210. Mapping functional components of a software application after redacting any sensitive portion of the software application provides a technical advantage by ensuring any sensitive or internal information is obfuscated while the software application is suitable for security testing and therefore, preventing any risk of intellectual property or proprietary loss.

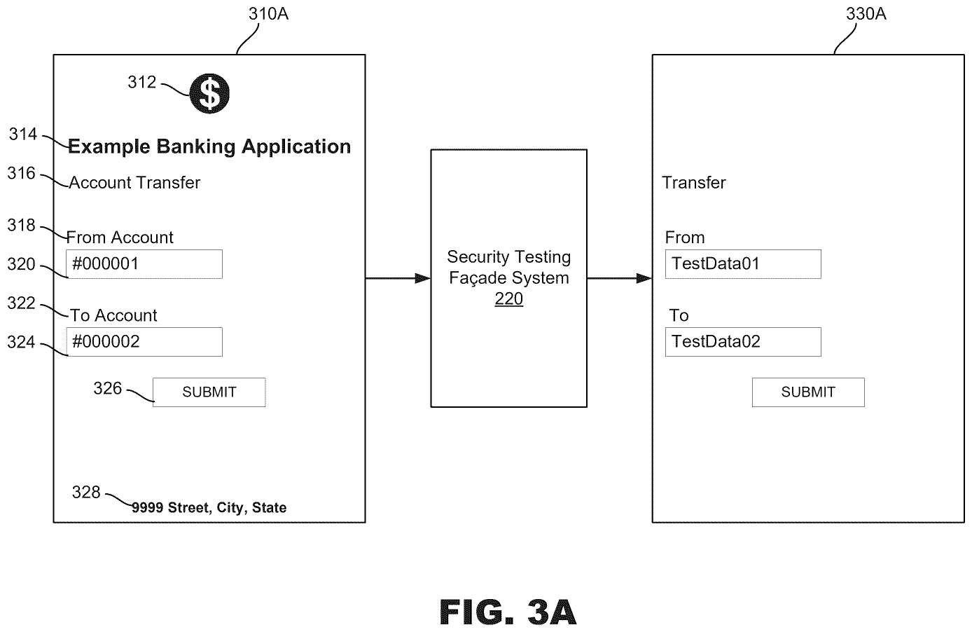

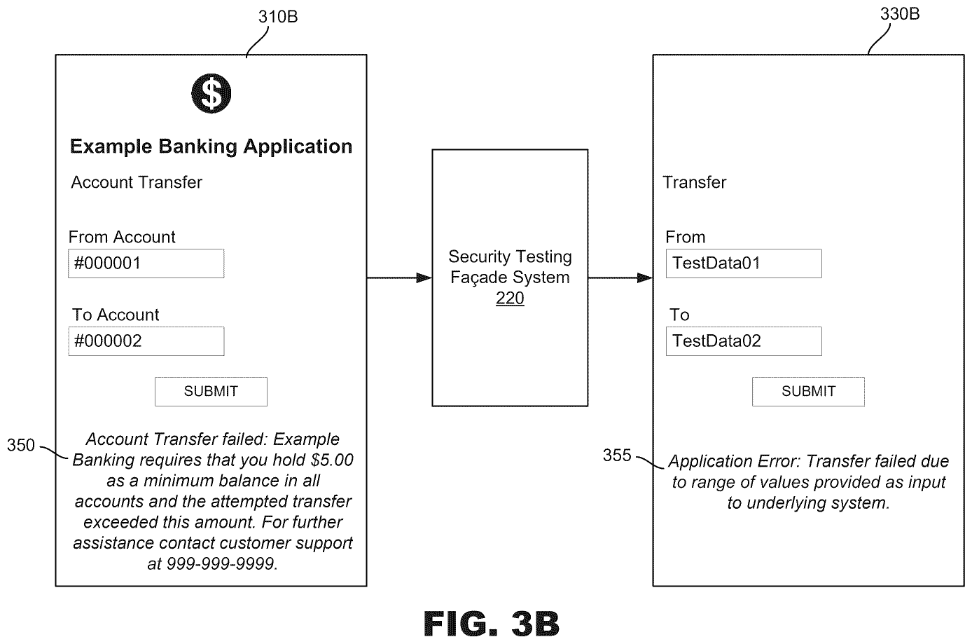

FIG. 3A is an example diagram illustrating an interface 310A, 330A before and after redacting data of a software application that contains sensitive internal information. The security testing façade system 220 can redact sensitive internal information on original interface 310A to generate a censored interface 330A. In this example, interface 310A, 330A is associated with a banking application.

As shown, the interface 310A comprises various components such as logo 312, business marking 314, transaction title 316, sender label 318, sender account number 320, recipient label 322, recipient account number 324, submit button 326 to send data, and business address 328. For example, security testing façade system 220 can (parse the raw data associated with the banking application) and identify the components.

As previously described, security testing façade system 220 can identify, among various components of original interface 310A, one or more components that include business-identifiable features such as logo 312, business marking 314, and business address 328. For example, the design or of logo 312 and business marking 314 may be specific to the business that provide the services associated with the banking application or can be intellectual property of the business (e.g., trademark). As follows, security testing façade system 220 can strip off logo 312, business marking 314, and business address 328 as shown in censored interface 330A.

Further, security testing façade system 220 can identify, among various components of original interface 310A, one or more components that may contain sensitive internal information such as sender account number 320 and recipient account number 324. As follows, security testing façade system 220 can change the sender account number 320 and recipient account number 324 into a generic data format or with generic test data as shown in censored interface 330A.

The security testing façade system 220 can identify any portion that may not be needed for security testing or does not affect the functionality of the application. For example, transaction title 316, sender label 318, and recipient label 322 in interface 310A can be simplified to include a minimum word or description as shown in censored interface 330A.

FIG. 3B is an example diagram illustrating an interface 310B, 330B before and after regenerating a component of a software application that contains sensitive internal information. The security testing façade system 220 can replace a textual component 350 in original interface 310B to generate a censored interface 330B with a summarized textual component 355. In this example, interface 310B, 330B is associated with a banking application.

In this example, security testing façade system 220 can identify a textual component 350, which describes an error message in original interface 310B. The security testing façade system 220 can then determine if a length of the text in textual component 350 exceeds a predetermined threshold length (e.g., number of words, number of lines, etc.).

The security testing façade system 220 can regenerate, using a generative AI model, new textual component 355 that includes a summarized text as shown in censored interface 330B. For example, a generative AI model (e.g., AI model 224) can analyze the original text in textual component 350 and generate a summarized textual component 355 as shown in censored interface 330B.

Further, security testing façade system 220 can remove a text(s) in textual component 350 that may be indicative of an organization (e.g., entity 202) or include sensitive internal information such as a phone number, business address, etc.

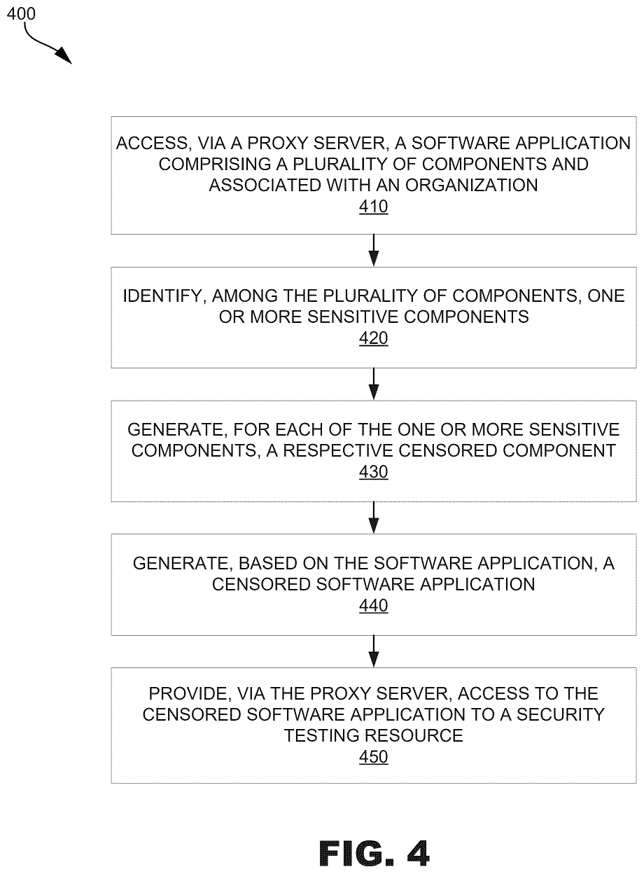

FIG. 4 illustrates a flowchart of an example method 400 for generating a censored software application to obfuscate sensitive component(s) for security testing, according to some examples of the present disclosure. Method 400 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 4, as will be understood by a person of ordinary skill in the art. Method 400 shall be described with reference to FIG. 2. However, method 400 is not limited to that example.

At step 410, method 400 includes accessing, via a proxy server, a software application comprising a plurality of components and associated with an organization. For example, security testing façade system 220 can access, via proxy 222, a software application 210 associated with entity 202. The software application 210 can include, for example and without limitation, a web-based application, a mobile application, or an API that is developed by or to be deployed by entity 202. Further, the software application (e.g., software application 210) can include a plurality of components such as visualization components (e.g., graphical elements) that are not related to the functionality of the software application, functional components that are related to the operation of the software application and need to be tested for security vulnerabilities, and so on.

At step 420, sensitive components of the software application can be identified. For example, security testing façade system 220 can identify, among the plurality of components, one or more sensitive components. The sensitive components can include any component that includes entity-identifiable features or internal information associated with the entity 202 such as a name, a logo, a symbol, a branding, a phone number, an address, an email address, member(s) or participants, an entity structure, and contact information associated with the organization.

At step 430, for each of the sensitive components, a respective censored component can be generated. For example, security testing façade system 220 can generate, for each of the one or more sensitive components, a respective censored component. The security testing façade system 220 can obfuscate any portion of the software application that includes the entity-identifiable features or internal information associated with entity 202 and generate a censored component (e.g., a blank component or a component replaced with generic information, etc.). Removing any business markers that are indicative of a particular entity is technically advantageous in business security and privacy as any content leakage associated with the business can be limited.

In some examples, security testing façade system 220 can use an AI model to generate the respective censored component based on a respective sensitive component. For example, AI model 224 can automatically and dynamically redact the portion of the software application that includes sensitive internal information associated with entity 202.

At step 440, based on the software application, a censored software application can be generated by replacing each of the one or more sensitive components with the respective censored component. For example, security testing façade system 220 can replace the sensitive components of software application 210 with the respective censored component and generate censored software application 230.

At step 450, security testing façade system 220 can provide, via the proxy server (e.g., proxy 222), access to the censored software application to a security testing resource. For example, censored software application 230 can be provided to security tester 240 over network(s) 118. As previously described, having a proxy server between the entity and the security testing resource offers a technical advantage as the proxy can provide an additional layer of security and privacy. The security testing façade system 220 acts as an intermediary between entity 202 and security tester 240 such that the censored software application 230 can be forwarded to security tester 240 with restricted access.

The disclosure now turns to a further discussion of example models (e.g., AI model) and devices that can be used to implement the technologies described herein.

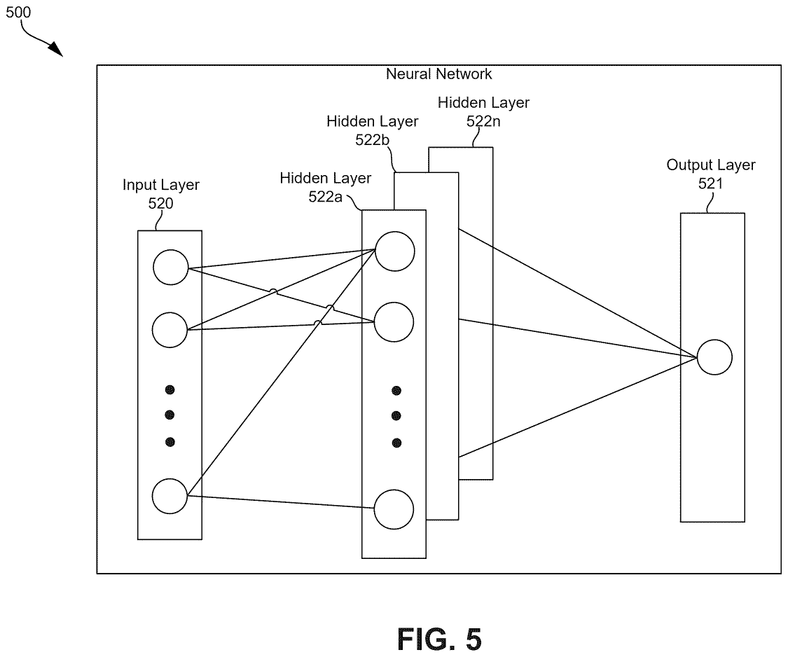

FIG. 5 is a diagram illustrating an example of a deep learning neural network 500 that can be used to implement all or a portion of the systems and techniques described herein, according to some examples of the present disclosure. For example, the neural network 500 can be used to implement the AI model 224 of the security testing façade system 220 and/or any other software model(s) described herein (and/or component thereof).

An input layer 520 can be configured to receive data such as data included in security testing façade system 220 and/or any other data described herein. Neural network 500 includes multiple hidden layers 522a, 522b, through 522n. The hidden layers 522a, 522b, through 522n include “n” number of hidden layers, where “n” is an integer greater than or equal to one. The number of hidden layers can be made to include as many layers as needed for the given application. Neural network 500 further includes an output layer 521 that provides an output resulting from the processing performed by the hidden layers 522a, 522b, through 522n.

Neural network 500 is a multi-layer neural network of interconnected nodes. Each node can represent a piece of information. Information associated with the nodes is shared among the different layers and each layer retains information as information is processed. In some cases, the neural network 500 can include a feed-forward network, in which case there are no feedback connections where outputs of the network are fed back into itself. In some cases, the neural network 500 can include a recurrent neural network, which can have loops that allow information to be carried across nodes while reading in input.

Information can be exchanged between nodes through node-to-node interconnections between the various layers. Nodes of the input layer 520 can activate a set of nodes in the first hidden layer 522a. For example, as shown, each of the input nodes of the input layer 520 is connected to each of the nodes of the first hidden layer 522a. The nodes of the first hidden layer 522a can transform the information of each input node by applying activation functions to the input node information. The information derived from the transformation can then be passed to and can activate the nodes of the next hidden layer 522b, which can perform their own designated functions. Example functions include convolutional, up-sampling, data transformation, and/or any other suitable functions. The output of the hidden layer 522b can then activate nodes of the next hidden layer, and so on. The output of the last hidden layer 522n can activate one or more nodes of the output layer 521, at which an output is provided. In some cases, while nodes in the neural network 500 are shown as having multiple output lines, a node can have a single output and all lines shown as being output from a node represent the same output value.

In some cases, each node or interconnection between nodes can have a weight that is a set of parameters derived from the training of the neural network 500. Once the neural network 500 is trained, it can be referred to as a trained neural network, which can be used to classify one or more activities. For example, an interconnection between nodes can represent a piece of information learned about the interconnected nodes. The interconnection can have a tunable numeric weight that can be tuned (e.g., based on a training dataset), allowing the neural network 500 to be adaptive to inputs and able to learn as more and more data is processed.

The neural network 500 is pre-trained to process the features from the data in the input layer 520 using the different hidden layers 522a, 522b, through 522n in order to provide the output through the output layer 521.

In some cases, the neural network 500 can adjust the weights of the nodes using a training process called backpropagation. A backpropagation process can include a forward pass, a loss function, a backward pass, and a weight update. The forward pass, loss function, backward pass, and parameter/weight update is performed for one training iteration. The process can be repeated for a certain number of iterations for each set of training data until the neural network 500 is trained well enough so that the weights of the layers are accurately tuned.

To perform training, a loss function can be used to analyze error in the output. Any suitable loss function definition can be used, such as a Cross-Entropy loss. Another example of a loss function includes the mean squared error (MSE), defined as E_total=Σ(½ (target-output)\hat{ }2). The loss can be set to be equal to the value of E_total.

The loss (or error) will be high for the initial training data since the actual values will be much different than the predicted output. The goal of training is to minimize the amount of loss so that the predicted output is the same as the training output. The neural network 500 can perform a backward pass by determining which inputs (weights) most contributed to the loss of the network, and can adjust the weights so that the loss decreases and is eventually minimized.

The neural network 500 can include any suitable deep network. One example neural network includes a Convolutional Neural Network (CNN), which includes an input layer and an output layer, with multiple hidden layers between the input and out layers. The hidden layers of a CNN include a series of convolutional, nonlinear, pooling (for downsampling), and fully connected layers. The neural network 500 can include any other deep network other than a CNN, such as a transformer, autoencoder, Deep Belief Net (DBN), Recurrent Neural Network (RNN), an encoder and/or decoder network, among others.

As understood by those of skill in the art, machine-learning based classification techniques can vary depending on the desired implementation. For example, machine-learning classification schemes can utilize one or more of the following, alone or in combination: hidden Markov models; RNNs; CNNs; deep learning; Bayesian symbolic methods; Generative Adversarial Networks (GANs); support vector machines; image registration methods; and applicable rule-based systems. Where regression algorithms are used, they may include but are not limited to: a Stochastic Gradient Descent Regressor, a Passive Aggressive Regressor, etc.

Machine learning classification models can also be based on clustering algorithms (e.g., a Mini-batch K-means clustering algorithm), a recommendation algorithm (e.g., a Minwise Hashing algorithm, or Euclidean Locality-Sensitive Hashing (LSH) algorithm), and/or an anomaly detection algorithm, such as a local outlier factor. Additionally, machine-learning models can employ a dimensionality reduction approach, such as, one or more of: a Mini-batch Dictionary Learning algorithm, an incremental Principal Component Analysis (PCA) algorithm, a Latent Dirichlet Allocation algorithm, and/or a Mini-batch K-means algorithm, etc.

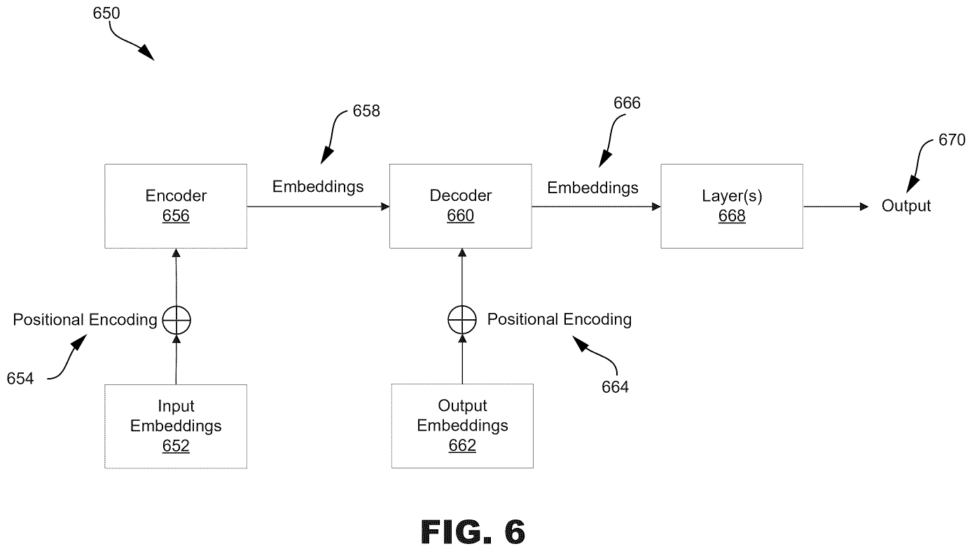

FIG. 6 is a diagram illustrating an example architecture of an example transformer model 650, according to some examples of the present disclosure. The transformer model 650 can be used to implement an LLM that can be used to implement the technologies described herein. For example, the transformer model 650 can be used to implement the AI model 224 of the security testing façade system 220 and/or any other model(s) described herein (and/or component thereof).

As shown, the transformer model 650 can include input embeddings 652 used as inputs to the transformer model 650. The input embeddings 652 can include input values representing words and/or sentences, such as numbers or vectors representing words and/or sentences.

In some cases, the input embeddings 652 can function like a dictionary that helps the transformer model 650 understand the meaning of words by placing them in an embedding space where similar words are located near each other. In some examples, AI model 224 can be trained and/or configured to create the input embeddings 652 so that similar vectors represent words with similar meanings (e.g., to regenerate text in the summarized textual component 355 as illustrated in FIG. 3B). In some examples, the transformer model 650 can additionally or alternatively learn to create and/or process the input embeddings 652 during training.

The transformer model 650 can use positional encoding 654 to encode the position of each word in an input sequence from the input embeddings 652 as values such as a set of numbers, a vector, etc. The values generated by the positional encoding 654 can be fed into the transformer model 650 along with the input embeddings 652. By incorporating the positional encoding 654 into the transformer model 650, the transformer model 650 can more effectively understand the order of words in a sentence and generate grammatically correct and semantically meaningful output.

The transformer model 650 can include an encoder(s) 656 used to process the positionally encoded input embeddings 652 and generate embeddings 658. The encoder(s) 656 can be part of the transformer model 650 that processes input text and generates hidden states that capture the meaning and context of the text. For example, the encoder(s) 656 can include a feed-forward neural network that is part of the transformer model 650. In some examples, the encoder(s) 656 can implement multiple encoder layers. In some cases, the encoder(s) 656 can first tokenize the input text into a sequence of tokens, such as individual words or subwords. The encoder(s) 656 can then apply one or more self-attention layers, which can generate hidden states that represent the input text at different levels of abstraction. In this way, the encoder(s) 656 can generate the embeddings 658 (e.g., a vector, a set of values, etc.) representing the semantics and position of words in one or more sentences.

The transformer model 650 can include output embeddings 662, which can include values representing words and/or sentences, such as numbers or vectors representing words and/or sentences. The output embeddings 662 can be similar to the input embeddings 652 and can also be processed by positional encoding 664 to encode the position of each word in a sequence from the output embeddings 662 as values such as a set of numbers, a vector, etc., which helps the transformer model 650 understand the order of words in a sentence. The output embeddings 662 can be used during a training phase of the transformer model 650 and can be used during an inference phase. During training, a loss function can be computed based on the output embeddings 662 and used to update the model parameters to improve the accuracy of the transformer model 650. During an inference phase, the output embeddings 662 can be used to generate the output text by mapping the predicted probabilities determined by the transformer model 650 for each token to the corresponding token in the vocabulary.

The positionally encoded input embeddings 652 (e.g., the embeddings 658) and the positionally encoded output embeddings 662 can be fed to a decoder(s) 660 used to generate the output sequence based on the encoded input sequence. During training, the decoder(s) 660 can learn how to guess the next word of a sequence by looking at the words before it. In some examples, the decoder(s) 660 can generate natural language text based on the input sequence and any learned context.

The decoder(s) 660 can generate embeddings 666 and feed the embeddings 666 to one or more network layers 668. In some examples, the one or more network layers 668 can include a linear layer and a softmax function. The linear layer can map the embeddings 666 generated by the decoder(s) 660 to a higher-dimensional space, which can transform the embeddings 666 into the original input space. The softmax function can then be applied to generate a probability distribution for each output token in the vocabulary, which can result in an output 670. In some examples, the output 670 can include output tokens with probabilities.

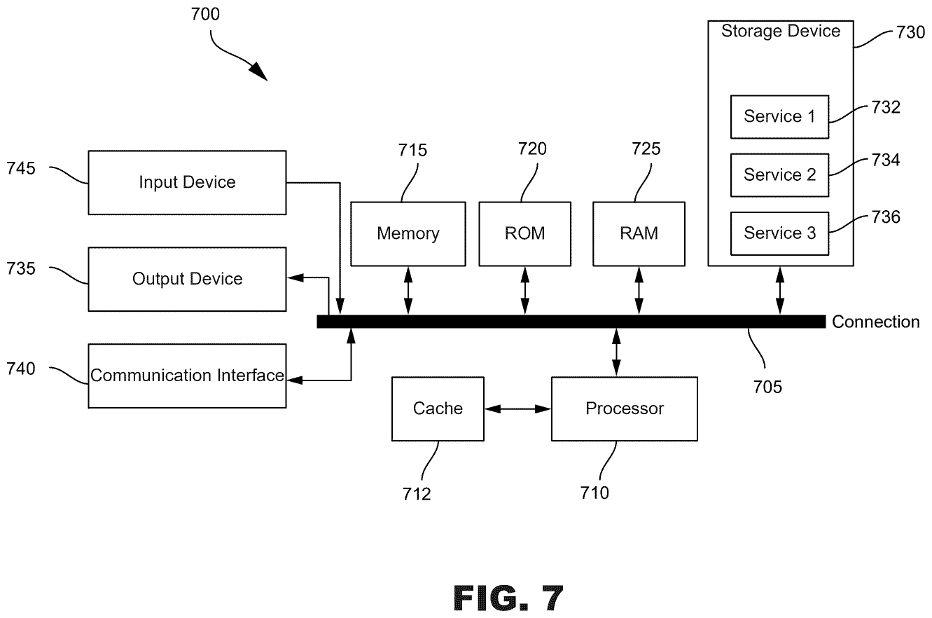

FIG. 7 illustrates an example processor-based system with which some examples of the subject technology can be implemented. For example, processor-based system 700 can be any computing device making up the security testing façade system 220, any of the client devices 116, or any component thereof in which the components of the system are in communication with each other using connection 705. Connection 705 can be a physical connection via a bus, or a direct connection into processor 710, such as in a chipset architecture. Connection 705 can also be a virtual connection, networked connection, or logical connection.

In some examples, computing system 700 is a distributed system in which the functions described in this disclosure can be distributed within a datacenter, multiple data centers, a peer network, etc. In some implementations, one or more of the described system components represents many such components each performing some or all of the function for which the component is described. In some embodiments, the components can be physical or virtual devices.

Example system 700 includes at least one processing unit (Central Processing Unit (CPU) or processor) 710 and connection 705 that couples various system components including system memory 715, such as Read-Only Memory (ROM) 720 and Random-Access Memory (RAM) 725 to processor 710. Computing system 700 can include a cache of high-speed memory 712 connected directly with, in close proximity to, or integrated as part of processor 710.

Processor 710 can include any general-purpose processor and a hardware service or software service, such as services 732, 734, and 736 stored in storage device 730, configured to control processor 710 as well as a special-purpose processor where software instructions are incorporated into the actual processor design. Processor 710 may essentially be a completely self-contained computing system, containing multiple cores or processors, a bus, memory controller, cache, etc. A multi-core processor may be symmetric or asymmetric.

To enable user interaction, computing system 700 includes an input device 745, which can represent any number of input mechanisms, such as a microphone for speech, a touch-sensitive screen for gesture or graphical input, keyboard, mouse, motion input, speech, etc. Computing system 700 can also include output device 735, which can be one or more of a number of output mechanisms known to those of skill in the art. In some instances, multimodal systems can enable a user to provide multiple types of input/output to communicate with computing system 700. Computing system 700 can include communications interface 740, which can generally govern and manage the user input and system output. The communication interface may perform or facilitate receipt and/or transmission wired or wireless communications via wired and/or wireless transceivers, including those making use of an audio jack/plug, a microphone jack/plug, a Universal Serial Bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a Radio-Frequency Identification (RFID) wireless signal transfer, Near-Field Communications (NFC) wireless signal transfer, Dedicated Short Range Communication (DSRC) wireless signal transfer, 802.11 Wi-Fi® wireless signal transfer, Wireless Local Area Network (WLAN) signal transfer, Visible Light Communication (VLC) signal transfer, Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer signal transfer, ultraviolet light signal transfer, wireless signal transfer along the electromagnetic spectrum, or some combination thereof.

Communication interface 740 may also include one or more Global Navigation Satellite System (GNSS) receivers or transceivers that are used to determine a location of the computing system 700 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 730 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a Compact Disc (CD) Read Only Memory (CD-ROM) optical disc, a rewritable CD optical disc, a Digital Video Disk (DVD) optical disc, a Blu-ray Disc (BD) optical disc, a holographic optical disk, another optical medium, a Secure Digital (SD) card, a micro SD (microSD) card, a Memory Stick® card, a smartcard chip, a EMV chip, a Subscriber Identity Module (SIM) card, a mini/micro/nano/pico SIM card, another Integrated Circuit (IC) chip/card, Random-Access Memory (RAM), Atatic RAM (SRAM), Dynamic RAM (DRAM), Read-Only Memory (ROM), Programmable ROM (PROM), Erasable PROM (EPROM), Electrically Erasable PROM (EEPROM), flash EPROM (FLASHEPROM), cache memory (L1/L2/L3/L4/L5/L #), Resistive RAM (RRAM/ReRAM), Phase Change Memory (PCM), Spin Transfer Torque RAM (STT-RAM), another memory chip or cartridge, and/or a combination thereof.

Storage device 730 can include software services, servers, services, etc., that when the code that defines such software is executed by the processor 710, it causes the system 700 to perform a function. In some embodiments, a hardware service that performs a particular function can include the software component stored in a computer-readable medium in connection with the necessary hardware components, such as processor 710, connection 705, output device 735, etc., to carry out the function.

Embodiments within the scope of the present disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other embodiments of the disclosure may be practiced in network computing environments with many types of computer system configurations, including personal computers, hand-held devices, multi-processor systems, microprocessor-based or programmable consumer electronics, network Personal Computers (PCs), minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope of the disclosure. For example, the principles herein apply equally to optimization as well as general improvements. Various modifications and changes may be made to the principles described herein without following the example embodiments and applications illustrated and described herein, and without departing from the spirit and scope of the disclosure.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

Illustrative examples of the present disclosure include:

Aspect 1. A computer-implemented method comprising: accessing, via a proxy server, a software application comprising a plurality of components and associated with an organization; identifying, among the plurality of components, one or more sensitive components; generating, for each of the one or more sensitive components, a respective censored component; generating, based on the software application, a censored software application by: replacing each of the one or more sensitive components with the respective censored component; and providing, via the proxy server, access to the censored software application to a security testing resource.

Aspect 2. The computer-implemented method of Aspect 1, wherein generating, for each of the one or more sensitive components, the respective censored component further comprises: generating, by an artificial intelligence model, the respective censored component based on a respective sensitive component.

Aspect 3. The computer-implemented method of any of Aspects 1 to 2, further comprising: identifying a textual component among the plurality of components, wherein the textual component includes a text that has a text length exceeding a threshold length; and regenerating, using a generative artificial intelligence model, the textual component that includes a summarized text.

Aspect 4. The computer-implemented method of Aspect 3, wherein regenerating the textual component comprises removing one or more terms indicative of the organization within the text.

Aspect 5. The computer-implemented method of any of Aspects 1 to 4, wherein the one or more sensitive components represent one or more features indicative of the organization.

Aspect 6. The computer-implemented method of Aspect 5, wherein the one or more features indicative of the organization include organizational information including at least one of a name, a logo, a symbol, a phone number, an address, and contact information associated with the organization.

Aspect 7. The computer-implemented method of any of Aspects 1 to 6, wherein the one or more sensitive components represent a visualization of the software application associated with the organization.

Aspect 8. The computer-implemented method of any of Aspects 1 to 7, further comprising: parsing raw data of the software application to identify the plurality of components.

Aspect 9. The computer-implemented method of any of Aspects 1 to 8, wherein generating the censored software application further comprises: mapping functional components of the software application, among the plurality of components, onto the censored software application, wherein the functional components are unchanged from the software application.

Aspect 10. The computer-implemented method of any of Aspects 1 to 9, wherein the one or more sensitive components are identified by a machine learning model, wherein the machine learning model is trained using organizational information.

Aspect 11. A system comprising: one or more processors; and at least one computer-readable storage medium having stored therein instructions which, when executed by the one or more processors, cause the one or more processors to: access, via a proxy server, a software application comprising a plurality of components and associated with an organization; identify, among the plurality of components, one or more sensitive components; generate, for each of the one or more sensitive components, a respective censored component; generate, based on the software application, a censored software application by: replacing each of the one or more sensitive components with the respective censored component; and provide, via the proxy server, access to the censored software application to a security testing resource.

Aspect 12. The system of Aspect 11, wherein generating, for each of the one or more sensitive components, the respective censored component further comprises: generating, by an artificial intelligence model, the respective censored component based on a respective sensitive component.

Aspect 13. The system of any of Aspects 11 to 12, wherein the instructions, when executed by the one or more processors, cause the one or more processors to: identify a textual component among the plurality of components, wherein the textual component includes a text that has a text length exceeding a threshold length; and regenerate, using a generative artificial intelligence model, the textual component that includes a summarized text.

Aspect 14. The system of Aspect 13, wherein regenerating the textual component comprises removing one or more terms indicative of the organization within the text.

Aspect 15. The system of any of Aspects 11 to 14, wherein the one or more sensitive components represent one or more features indicative of the organization.

Aspect 16. The system of Aspect 15, wherein the one or more features indicative of the organization include organizational information including at least one of a name, a logo, a symbol, a phone number, an address, and contact information associated with the organization.

Aspect 17. The system of any of Aspects 11 to 16, wherein the one or more sensitive components represent a visualization of the software application associated with the organization.

Aspect 18. The system of any of Aspects 11 to 17, wherein the instructions, when executed by the one or more processors, cause the one or more processors to: parse raw data of the software application to identify the plurality of components.

Aspect 19. The system of any of Aspects 11 to 18, wherein generating the censored software application further comprises: mapping functional components of the software application, among the plurality of components, onto the censored software application, wherein the functional components are unchanged from the software application.

Aspect 19. A non-transitory computer-readable medium having instructions stored thereon that, when executed by one or more processors, cause the one or more processors to perform a method according to any of Aspects 11 to 10.

Aspect 21. A system comprising means for performing a method according to any of Aspects 1 to 10.

Aspect 22. A computer-program product having stored thereon instructions which, when executed by one or more processors, cause the one or more processors to perform a method according to any of Aspects 1 to 10.

What is claimed is:

1. A computer-implemented method comprising:
accessing, via a proxy server, a software application comprising a plurality of components and associated with an organization;
identifying, among the plurality of components, one or more sensitive components;
generating, for each of the one or more sensitive components, a respective censored component;
generating, based on the software application, a censored software application by:
replacing each of the one or more sensitive components with the respective censored component; and
providing, via the proxy server, access to the censored software application to a security testing resource.

2. The computer-implemented method of claim 1, wherein generating, for each of the one or more sensitive components, the respective censored component further comprises:
generating, by an artificial intelligence model, the respective censored component based on a respective sensitive component.

3. The computer-implemented method of claim 1, further comprising:
identifying a textual component among the plurality of components, wherein the textual component includes a text that has a text length exceeding a threshold length; and
regenerating, using a generative artificial intelligence model, the textual component that includes a summarized text.

4. The computer-implemented method of claim 3, wherein regenerating the textual component comprises removing one or more terms indicative of the organization within the text.

5. The computer-implemented method of claim 1, wherein the one or more sensitive components represent one or more features indicative of the organization.

6. The computer-implemented method of claim 5, wherein the one or more features indicative of the organization include organizational information including at least one of a name, a logo, a symbol, a phone number, an address, and contact information associated with the organization.

7. The computer-implemented method of claim 1, wherein the one or more sensitive components represent a visualization of the software application associated with the organization.

8. The computer-implemented method of claim 1, further comprising:
parsing raw data of the software application to identify the plurality of components.

9. The computer-implemented method of claim 1, wherein generating the censored software application further comprises:
mapping functional components of the software application, among the plurality of components, onto the censored software application, wherein the functional components are unchanged from the software application.

10. The computer-implemented method of claim 1, wherein the one or more sensitive components are identified by a machine learning model, wherein the machine learning model is trained using organizational information.

11. A system comprising:
one or more processors; and
at least one computer-readable storage medium having stored therein instructions which, when executed by the one or more processors, cause the one or more processors to:
access, via a proxy server, a software application comprising a plurality of components and associated with an organization;
identify, among the plurality of components, one or more sensitive components;
generate, for each of the one or more sensitive components, a respective censored component;
generate, based on the software application, a censored software application by:
replacing each of the one or more sensitive components with the respective censored component; and
provide, via the proxy server, access to the censored software application to a security testing resource.

12. The system of claim 11, wherein generating, for each of the one or more sensitive components, the respective censored component further comprises:
generating, by an artificial intelligence model, the respective censored component based on a respective sensitive component.

13. The system of claim 11, wherein the instructions, when executed by the one or more processors, cause the one or more processors to:
identify a textual component among the plurality of components, wherein the textual component includes a text that has a text length exceeding a threshold length; and
regenerate, using a generative artificial intelligence model, the textual component that includes a summarized text.

14. The system of claim 13, wherein regenerating the textual component comprises removing one or more terms indicative of the organization within the text.

15. The system of claim 11, wherein the one or more sensitive components represent one or more features indicative of the organization.

16. The system of claim 15, wherein the one or more features indicative of the organization include organizational information including at least one of a name, a logo, a symbol, a phone number, an address, and contact information associated with the organization.

17. The system of claim 11, wherein the one or more sensitive components represent a visualization of the software application associated with the organization.

18. The system of claim 11, wherein the instructions, when executed by the one or more processors, cause the one or more processors to:
parse raw data of the software application to identify the plurality of components.

19. The system of claim 11, wherein generating the censored software application further comprises:
mapping functional components of the software application, among the plurality of components, onto the censored software application, wherein the functional components are unchanged from the software application.

20. A non-transitory computer-readable medium having stored thereon instructions which, when executed by one or more processors, cause the one or more processors to:
access, via a proxy server, a software application comprising a plurality of components and associated with an organization;
identify, among the plurality of components, one or more sensitive components;
generate, for each of the one or more sensitive components, a respective censored component;
generate, based on the software application, a censored software application by:
replacing each of the one or more sensitive components with the respective censored component; and
provide, via the proxy server, access to the censored software application to a security testing resource.
